(19) United States
(12) Patent Application Publication
(10) Pub. No.: US 2007/0158262 A1
(43) Pub. Date: Jul. 12, 2007

(54) Water treatment system arrangement

(76) Inventors: Harry Manvel, Waterford, MI (US); George R. Babb, Grand Rapids, MI (US)

Correspondence Address: ROHM & MONSANTO, PLC, 12 Rathbone Place, Grosse Pointe, MI, 48230, US

(21) Appl. No.: 11/651,228

(22) Filed: Jan. 9, 2007

Related U.S. Application Data
(60) Provisional application No. 60/757,571, filed on Jan. 9, 2006.

(51) Int. Cl. B01D 35/28

(52) U.S. Cl. 210/435; 422/129; 422/139

(57) ABSTRACT

A water treatment system is provided with a fluidized bed reaction vessel having a water inlet and a water outlet, the reaction vessel having a region of continuously varying cross-sectional area intermediate of the water inlet and the water outlet. The continuously varying cross-sectional area intermediate of the water inlet and the water outlet of the reaction vessel is configured as a substantially truncated conical internal surface. A region of substantially constant cross-sectional area intermediate of the water inlet and the water outlet, the region of substantially constant cross-sectional area is coaxially disposed in relation to the region of continuously varying cross-sectional area. The region of substantially constant cross-sectional area comprises a substantially cylindrical internal surface. Also, the region of substantially constant cross-sectional area is axially adjacent to a region of diminished cross-sectional area of the region of continuously varying cross-sectional area. A tilt arrangement facilitates tilting of the reaction vessel for performing maintenance thereon. Additionally, a filter arrangement for filtering the water being treated includes a screen filter or a sand filter.

### CROSS REFERENCE TO RELATED APPLICATION(S)

This application claims the benefit of the filing date of Provisional Patent Application Ser. No. 60/757,571 filed Jan. 9, 2006.

### BACKGROUND OF THE INVENTION

1. Field of the Invention

This invention relates generally to cooling tower water treatment systems, and more particularly, to a cooling tower treatment system arrangement having a portion of a reaction vessel with a continuously varying internal diameter.

2. Description of the Related Art

Water is the most commonly used medium for removing heat from industrial equipment, as it has excellent heat transfer capability that is reversible whereby the water can be cooled and reused. Typically, water is recycled by the use of a heat exchanger that employs a cooling tower that allows a portion of the water to be evaporated. A conventional cooling tower will employ a large internal surface that has one or more stepwise reductions in internal diameter over which the warm water cascades. Fans may be employed to move air over the cascading water to facilitate lowering the temperature through evaporation. The tower discharge water then is returned to a reservoir for re-use. There is a need for a cooling tower treatment system arrangement that has a reaction vessel that can provide a greater capacity to treat the water without increasing the footprint. Such an enhanced capacity will permit a greater amount of media to flow through, without requiring additional reaction columns or devices. Additionally, greater flexibility would be achieved in the determination of the amount of media that will be processed.

In addition to the foregoing, conventional reaction vessels present difficulty in cleaning. In many cases, the tower, and sometimes the reservoir, are located outdoors where they are exposed to sunlight and airborne contaminants. Since water is rarely pure, contaminants in the water are concentrated during the evaporation process. Concentration of the contaminants leads to multiple problems such as scaling, corrosion and fouling by algae, bacteria, and fungi, the treatment of which require the use of chemicals and/or frequent maintenance. There is, therefore, a need for a reaction vessel that can readily be cleaned, and from which media can be removed without requiring disassembly.

Water is typically treated with chemical conditioners to control scaling, corrosion and biofouling. Chelators and complexers are added to control the formation of scale, inhibitors have been added to control corrosion, and biocides have been added to control biofouling. In addition to the foregoing, other additives such as buffers and pH control additives are frequently used. The use of these chemicals adds expense, increases effort to monitor and maintain appropriate chemical levels, and creates disposal problems.

Non-chemical systems have been developed, such as magnetic systems and ozone generators, but these have proven to be expensive and only marginally effective. Ozone systems, for example, have a beneficial effect on the control of biofouling, but have a limited effect on the control of scale formation and corrosion protection.

A unique oxidation/reduction (redox) media has been discovered for treating water by the galvanic reaction that results when the water contacts bimetallic redox media. The bimetallic alloy used in the media for water treatment is preferably a high purity alloy of copper and zinc in an appropriate ratio. The redox media is described more particularly, for example, in U.S. Pat. Nos. 5,510,034; 5,433,856; and related patents. Redox potential (ORP) is a measure of the readiness to part with electrons, and is measured in millivolts (mV). Zinc is more reactive than copper and is more electropositive. In the preferred redox filter media, copper is the permanent cathode and zinc is the sacrificial anode. A single pass through copper-zinc redox filter media rapidly changes the redox potential of water from +200 mV to −500 mV. This change has a dramatic effect on most bacteriologic, solubility, and ionic reactions. The redox media can remove dissolved gases such as chlorine, hydrogen sulfide and methane. It can also remove virtually any soluble heavy metal, help prevent mineral scale accumulation and reduce levels of microorganisms.

When cooling tower water is exposed to redox media, the flow of electrons alters the crystalline structure of the scale-forming compounds. The most common scale-forming compound is calcium carbonate or calcite. When combined with carbon dioxide dissolved from the air, and exposed to heat, calcite is deposited in the heat exchangers, pipes, pumps, reservoirs, reaction vessels, and towers used in the cooling system. Left uncontrolled, calcite will continue to grow upon itself until a thick layer of scale is formed. A 0.1″ thick deposit of calcite will reduce the ability of a heat exchanger to transfer heat by about 40%. The modification of ORP produced by the redox media causes the calcium to precipitate as fine particles of a carbonate compound that is spherical or rod-shaped with rounded edges. Unlike the coarse crystalline calcite scale, the carbonate precipitate cannot grow upon itself and can be removed by filtration.

The medium controls biofouling by two mechanisms. The ORP change produced by contact with the media results in an electrolytic field that most microorganisms cannot survive. Second, hydroxyl radicals and peroxides are formed from some of the water molecules that adversely impact microorganisms. Finally, the corrosion of metallic surfaces is mitigated by the stabilization of pH to non-corrosive alkaline levels of between 8.0 and 8.5 through the generation of hydroxyl radicals by the redox media. Additionally, the negative impact on bacterial growth prevents the generation of organic acids by the bacteria.

Despite these advantages, the use of the aforementioned redox media has been accompanied by the several disadvantages. In typical systems, the redox media is supplied in a form similar to steel wool. This material is formed around a mandrel, whereby water flows from the outside of the chamber, through the media, and through the mandrel. In another embodiment, the redox media is supplied in the form of a foam-like product that has been formed into discs. The water flows through a series of these discs for the appropriate contact time. The wool and foam products, being held in a static position, become clogged over time with particulate matter that is precipitated out of the water. Not only does this require frequent replacement of the media, but as clogging occurs, the surface area is reduced and flow is restricted. As a result of this deterioration, performance is reduced and the problems relating to scale, biofouling, and corrosion can recur.

In order to overcome the foregoing problem, a granular media has been used in the prior art with a downflow pattern in a pressure vessel. While this also results in a buildup of trapped particulates, periodic back washing allows their removal. This known arrangement constitutes an improvement over the wool and foam systems where the media is permanently fouled, but is plagued with diminished performance between back washing cycles. Another disadvantage of this known arrangement is that media is lost during the back washing procedure that is necessary for removal of the captured particles.

It is, therefore, an object of this invention to provide a cooling tower water treatment system arrangement that has a reaction vessel that can achieve greater capacity than reaction vessels currently in use.

It is a further object of this invention to provide a reaction vessel arrangement that achieves a greater cost benefit over those currently in use in cooling tower water treatment system arrangements.

It is another object of this invention to provide a cooling tower water treatment system arrangement that can be maintained more easily than cooling tower water treatment system arrangements currently in use.

It is also an object of this invention to provide a cooling tower water treatment system arrangement that affords greater flexibility in the determination of the amount of media that can be employed in an application.

It is additionally an object of this invention to provide a cooling tower water treatment system arrangement that does not require the use of an expensive or complicated filter system.

### SUMMARY OF THE INVENTION

The foregoing and other objects are achieved by this invention which provides in accordance with a first apparatus aspect, a cooling tower water treatment system having a fluidized bed reaction vessel. The reaction vessel is provided with a water inlet and a water outlet, the reaction vessel having a region of continuously varying cross-sectional area intermediate of the water inlet and the water outlet.

In one embodiment of the cooling tower water treatment system, the continuously varying cross-sectional area intermediate of the reaction vessel inlet and the reaction vessel outlet of the reaction vessel is configured as a substantially truncated conical internal surface. Thus, in this embodiment the cross-sectional area of the reaction vessel varies continuously in relation to longitudinal axis. More specifically, the cross-sectional area of the reaction vessel increases continuously in the direction of the flow of the water being treated.

In a specific illustrative embodiment of the invention, there is further provided a region of substantially constant cross-sectional area intermediate of the reaction vessel tower inlet and the reaction vessel outlet, the region of substantially constant cross-sectional area being axially disposed in relation to the region of continuously varying cross-sectional area. In this embodiment, the region of substantially constant cross-sectional area comprises a substantially cylindrical internal surface. Also, the region of substantially constant cross-sectional area is coaxially adjacent to a region of diminished cross-sectional area of the region of continuously varying cross-sectional area.

In a highly advantageous embodiment of the invention, there is further provided a tilt arrangement for facilitating tilting of the reaction vessel for performing maintenance thereon.

There is further provided a filter arrangement for filtering the water being treated. The filter arrangement includes selectably a screen filter or a sand filter.

In accordance with a further apparatus aspect of the invention, there is provided a reaction vessel for a cooling tower water treatment system, the reaction vessel having a water inlet and a water outlet. A first axial region of the reaction vessel is disposed intermediate of the water inlet and the water outlet, the first axial region having a continuously varying cross-sectional area.

In one embodiment, the reaction vessel intermediate of the water inlet and the water outlet constitutes a truncated substantially conical internal surface.

In a further embodiment, there is additionally provided a further axial region of the reaction vessel intermediate of the water inlet and the water outlet, the further axial region having a substantially constant cross-sectional area. The further axial region of the reaction vessel is coaxially arranged in relation to the first axial region of the reaction vessel.

In an advantageous embodiment of this further apparatus aspect of the invention, there is provided a tilt arrangement for facilitating tilting of the reaction vessel for performing maintenance thereon.

As noted in relation to the first apparatus aspect, there is further provided a filter arrangement for filtering the water being treated. The filter arrangement includes a screen filter and/or a sand filter.

### BRIEF DESCRIPTION OF THE DRAWING

Comprehension of the invention is facilitated by reading the following detailed description, in conjunction with the annexed drawing, in which:

FIG. 1 is a perspective representation of a specific illustrative embodiment of the invention showing the reaction vessel in a tilted condition;

FIG. 2 is a perspective representation of a specific illustrative embodiment of the invention showing the reaction vessel in an upright condition;

FIG. 3 is a simplified schematic front plan representation of a specific illustrative embodiment of the invention;

FIG. 4 is a simplified schematic side plan representation of the embodiment of the invention shown in FIG. 3;

FIG. 5 is a simplified schematic representation of a reaction vessel arrangement having a region of continuously varying cross-sectional area, coupled to a coaxially arranged region having a constant cross-sectional area;

FIG. 6 is a simplified schematic representation and end view of the reaction vessel arrangement of FIG. 5;

FIG. 7 is a perspective representation of the embodiment of FIG. 6, and

FIG. 8 is a simplified schematic representation of a cooling tower treatment system constructed in accordance with the principles of invention.

### DETAILED DESCRIPTION

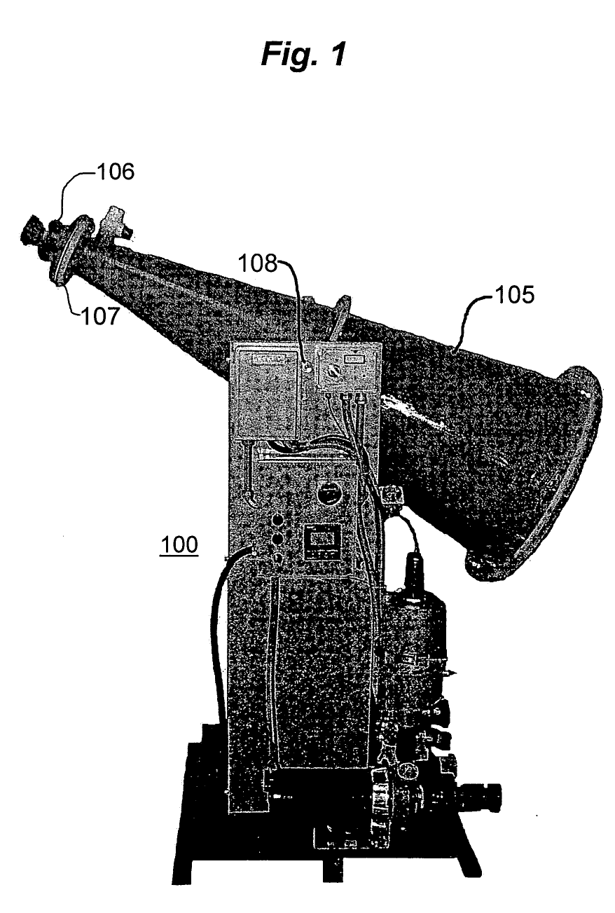

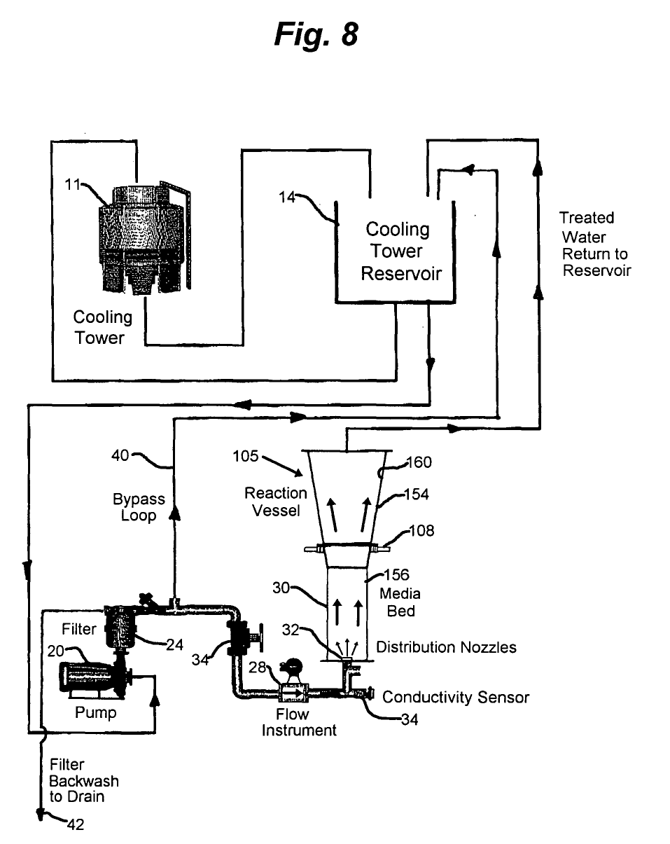

FIG. 1 is a perspective representation of a specific illustrative embodiment of the inventive water treatment system 100 showing the reaction vessel 105 in a tilted condition. There is provided in this embodiment a tilt arrangement 108 that facilitates the orientation of reaction vessel 105 to the tilted condition. While in the tilted condition, maintenance and cleaning of the cooling tower are facilitated. This figure shows reaction vessel 105 to have a nozzle arrangement 106. Nozzle arrangement 106 has associated therewith a baffle plate 107. In this specific illustrative embodiment of the invention, baffle plate 107 has a plurality of holes (not shown) arranged in a circular pattern and angled, illustratively at 45°. Some of the elements of structure associated with water treatment system 100 are shown schematically in FIG. 8 and will be discussed below in relation thereto.

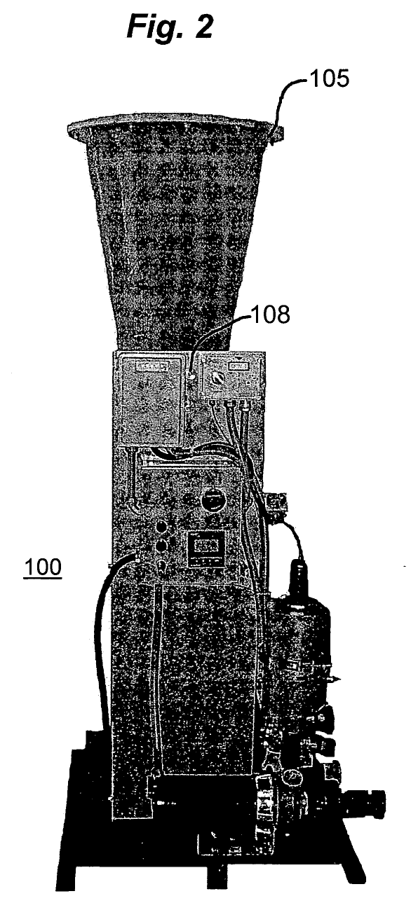

FIG. 2 is a perspective representation of a specific illustrative embodiment of the inventive water treatment system 100 of FIG. 1 showing reaction vessel 105 in an upright condition. Elements of structure that have previously been discussed are similarly designated in this figure.

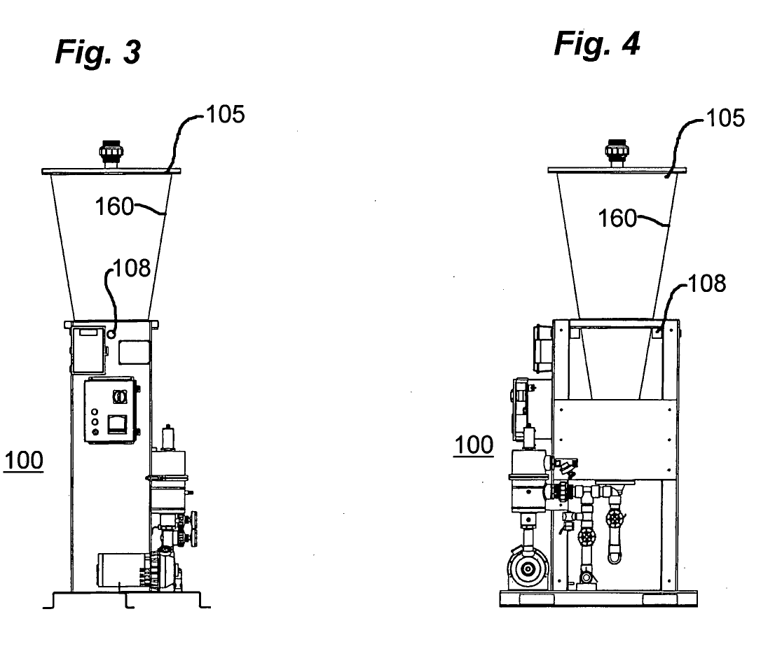

FIG. 3 is a simplified schematic front plan representation of a specific illustrative embodiment of the inventive water treatment system 100 showing reaction vessel 105 in an upright condition. Elements of structure that have previously been discussed are similarly designated in this figure. As will be shown in greater detail in relation to FIG. 7, this figure shows reaction vessel 105 to have a substantially conical internal surface 160.

FIG. 4 is a simplified schematic side plan representation of the embodiment of the inventive water treatment system 100 shown in FIG. 3. Elements of structure that have previously been discussed are similarly designated in this figure.

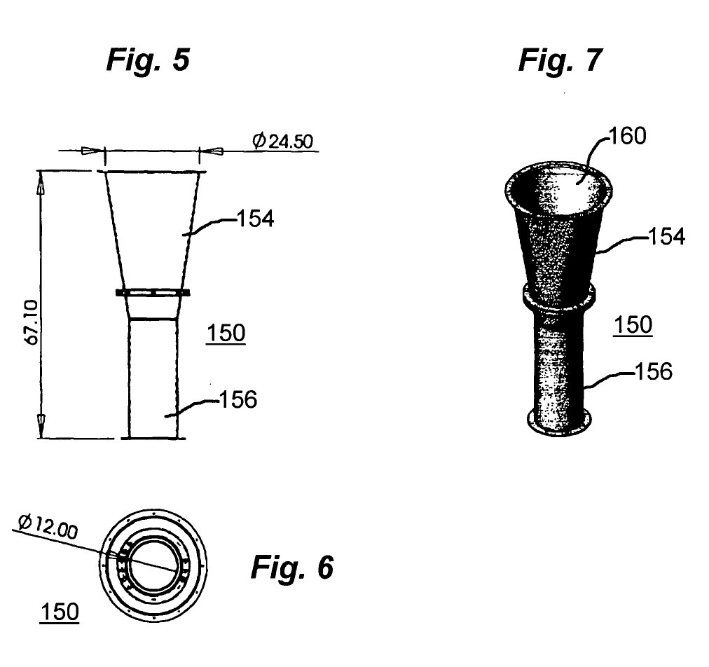

FIG. 5 is a simplified schematic representation of a reaction vessel arrangement 150 having a region of continuously varying cross-sectional area 154, coupled to a coaxially arranged region having a constant cross-sectional area 156. In this specific illustrative embodiment of the invention, reaction vessel arrangement 150 has an overall length of 67.1 inches. The larger diameter portion of region of continuously varying cross-sectional area 154 is 24.50 inches, tapering conically to a diameter of 12.00 inches, as shown in FIG. 6. FIG. 6 is a simplified schematic representation and end view of reaction vessel arrangement 150 of FIG. 5. In this specific illustrative embodiment of the invention, region of constant cross-sectional area 156 has a substantially conical configuration with an internal diameter of 12.00 inches.

FIG. 7 is a perspective representation of reaction vessel arrangement 150 of FIGS. 5 and 6. Elements of structure that have previously been discussed are similarly designated in this figure. This figure shows a region of continuously varying cross-sectional area 154, coupled to a coaxially arranged region having a constant cross-sectional area 156. Additionally, there is seen in this figure a substantially conical internal surface 160 on the interior of continuously varying cross-sectional area 154.

FIG. 8 is a simplified schematic representation of a cooling tower treatment system constructed in accordance with the principles of invention. Elements of structure that have previously been discussed are similarly designated in this figure. A typical cooling tower system, portions of which are illustrated in this figure, includes a cooling tower 11 that is incorporated in a water loop with a cooling tower reservoir 14. Water to be treated is conducted to a pump 20 that pumps the water to be treated through a filter 24. Filter 24, in this specific illustrative embodiment of the invention, contains within it a screen filter (not shown). In other embodiments, the filter may contain a sand filter (not shown). The quantity of the water that is delivered to media bed 30 is monitored by a flow instrument 28.

The water is delivered to media bed 30 via one or more distribution nozzles 32. Chemical characteristics of the water to be treated are monitored by a conductivity sensor 34 prior to being introduced into media bed 30 of the reaction vessel, that is generally designated as 105. The media bed is contained, in this specific illustrative embodiment of the invention, within the region described hereinabove having a constant cross-sectional area 156.

The region having a constant cross-sectional area 156 of reaction vessel 105 is shown coaxially arranged in relation to a substantially conical internal surface 160 on the interior of a region having continuously varying cross-sectional area 154, as previously described. The interior surface 160 of reaction vessel 105 has a substantially conical configuration in this specific illustrative embodiment of the invention, and as shown, the water being treated flows in the direction of increasing cross-sectional area. Also as previously described, reaction vessel 105 is pivotable about tilt arrangement 108 (shown schematically), to facilitate maintenance and cleaning. Inventive reaction vessel 105, as previously discussed, has a large interior surface area having a continuously varying cross-sectional area over which warm water (not shown) cascades.

The reaction vessel discharge water (not specifically designated) flows in the direction of increasing cross-sectional area. It is then returned to reservoir 11 for re-use.

Periodically, valve 34 is operated to create a backwash cycle for filter 24. The filter backwash fluid being disposed at a drain 42 which, in certain embodiments, may be discharged to a sewer line (not shown).

Additionally, a bypass loop 40 in combination with the manual valve, allows for precise adjustment of flow through the reaction column, with excess water flow bypassing back to the reservoir.

Although the invention has been described in terms of specific embodiments and applications, persons skilled in the art may, in light of this teaching, generate additional embodiments without exceeding the scope or departing from the spirit of the invention described herein. Accordingly, it is to be understood that the drawing and description in this disclosure are proffered to facilitate comprehension of the invention, and should not be construed to limit the scope thereof.

What is claimed is:

1. A water treatment system comprising a reaction vessel having a water inlet and a water outlet, said reaction vessel having a region of continuously varying cross-sectional area intermediate of the water inlet and the water outlet.

2. The water treatment system of claim 1, wherein the continuously varying cross-sectional area intermediate of the water inlet and the water outlet of said reaction vessel comprises a substantially truncated conical internal surface.

3. The water treatment system of claim 1, wherein there is further provided a region of substantially constant cross-sectional area intermediate of the water inlet and the water outlet, said region of substantially constant cross-sectional area being axially disposed in relation to said region of continuously varying cross-sectional area.

4. The water treatment system of claim 3, wherein said region of substantially constant cross-sectional area comprises a substantially cylindrical internal surface.

5. The water treatment system of claim 4, wherein said region of substantially constant cross-sectional area is coaxially adjacent to a region of varying cross-sectional area of said region of continuously varying cross-sectional area.

6. The water treatment system of claim 1, wherein there is further provided a tilt arrangement for facilitating tilting of said reaction vessel for performing maintenance thereon.

7. The water treatment system of claim 1, wherein there is further provided a filter arrangement for filtering the water being treated.

8. The water treatment system of claim 7, wherein said filter arrangement comprises a screen filter.

9. A reaction vessel for a water treatment system, the reaction vessel comprising a water inlet, a water outlet, and a first axial region of said reaction vessel arranged intermediate of the water inlet and the water outlet, said first axial region having a continuously varying cross-sectional area.

10. The reaction vessel of claim 9, wherein said first region of the reaction vessel intermediate of the water inlet and the water outlet comprises a truncated substantially conical internal surface.

11. The reaction vessel of claim 9, wherein there is further provided a further axial region of the reaction vessel intermediate of the water inlet and the water outlet, said further axial region having a substantially constant cross-sectional area.

12. The reaction vessel of claim 11, wherein said further axial region of the reaction vessel is axially arranged in relation to said first axial region of the reaction vessel.

13. The reaction vessel of claim 9, wherein there is further provided a tilt arrangement for facilitating tilting of the reaction vessel for performing maintenance thereon.

14. The reaction vessel of claim 9, wherein there is further provided a filter arrangement for filtering the water being treated.

15. The reaction vessel of claim 14, wherein said filter arrangement comprises a screen filter.
